(19) United States
(12) Patent Application Publication
(10) Pub. No.: US 2007/0234085 A1
(43) Pub. Date: Oct. 4, 2007

(54) Power supply control device and power supply control method

(76) Inventors: Hirohito Motomiya, Higashiyamato-shi (JP); Shizuo Morioka, Hanno-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/728,473

(22) Filed: Mar. 26, 2007

(30) Foreign Application Priority Data
Mar. 28, 2006 (JP) 2006-088884

(51) Int. Cl. G06F 1/00

(52) U.S. Cl. 713/300

(57) ABSTRACT

According to one embodiment, a power supply control device controls a switching power supply circuit by a pulse width modulation signal. The power supply control device includes a memory which stores a control program including a plurality of instructions for executing a procedure of a power supply control process which controls a duty ratio of the pulse width modulation signal based on an output voltage value of the switching power supply circuit and a target voltage value, a total execution time of the plurality of instructions included in the control program agreeing with a period of the pulse width modulation signal, and a processing unit which executes the power supply control process for each period of the pulse width modulation signal by repeatedly executing the plurality of instructions included in the control program without interruption.

### CROSS-REFERENCE TO RELATED APPLICATIONS

This application is based upon and claims the benefit of priority from Japanese Patent Application No. 2006-088884, filed Mar. 28, 2006, the entire contents of which are incorporated herein by reference.

### BACKGROUND

1. Field

One embodiment of the invention relates to a power supply control device which controls a switching power supply circuit by a pulse width modulation signal, and an electronic apparatus including the power supply control device.

2. Description of the Related Art

In general, in electronic apparatuses such as a computer, a TV and a video recorder, a switching power supply circuit which functions as a DC/DC converter is provided. The output voltage value of the switching power supply circuit is controlled by a duty ratio of a pulse width modulation signal (PWM signal) that is supplied to the switching power supply circuit.

Recently, a power supply control device, which is composed of a DSP (Digital Signal Processor) or a 1-chip microcomputer, has begun to be developed. In this power supply control device, a power supply control process for controlling the duty ratio of the PWM signal, which is supplied to the switching power supply circuit, is executed by a processing unit such as a CPU.

Jpn. Pat. Appln. KOKAI Publication No. 11-242502 discloses a power supply control device including a CPU which controls the duty ratio of the PWM signal for each predetermined period.

In the meantime, in order to execute the power supply control process for each period of the PWM signal, it is necessary to execute the arithmetic operation of the processing unit in sync with the PWM signal.

For example, the arithmetic operation of the processing unit can be synchronized with the PWM signal, by periodically supplying an interrupt signal to the power supply control device for each period of the PWM signal.

However, in general, a predetermined delay time (overhead) is needed until the processing unit actually starts the arithmetic operation after the input of the interrupt signal. Thus, the power supply control process is required to be completed within a time period, which is calculated by subtracting a delay time from one period of the PWM signal.

Hence, in order to execute the power supply control process for each period of the PWM signal, the period of the PWM signal has to be made longer or the power supply control device including a processing unit, which can perform a high-speed operation, has to be used.

However, if the period of the PWM signal is made longer, that is, if the frequency of the PWM signal is made lower, the response characteristic of the power supply control process deteriorates. In addition, the use of the power supply control device including a processing unit, which can perform a high-speed operation, leads to an increase in cost.

Therefore, it is necessary to realize a novel function which can execute the power supply control process for each period of the PWM signal with a little overhead.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view that shows a general appearance of a computer according to an embodiment of the invention;

FIG. 2 is an exemplary block diagram showing an example of the system configuration of the computer shown in FIG. 1;

FIG. 3 is an exemplary block diagram showing an example of the structure of a power supply control device which is provided in the computer shown in FIG. 1;

FIG. 4 is an exemplary diagram showing an example of the structure of a control program for controlling the operation of the power supply control device shown in FIG. 3;

FIG. 5 is an exemplary diagram showing an example of a process for adjusting the execution time of an instruction group which is included in the control program for controlling the operation of the power supply control device shown in FIG. 3;

FIG. 6 is an exemplary diagram showing another example of the process for adjusting the execution time of the instruction group which is included in the control program for controlling the operation of the power supply control device shown in FIG. 3;

FIG. 7 is an exemplary flow chart illustrating an example of the operation that is executed by a processing unit which is provided in the power supply control device shown in FIG. 3;

FIG. 8 is an exemplary flow chart illustrating the content of a power supply control process that is executed by the processing unit which is provided in the power supply control device shown in FIG. 3;

FIG. 9 is an exemplary diagram showing another example of the structure of the control program for controlling the operation of the power supply control device shown in FIG. 3;

FIG. 10 is an exemplary flow chart illustrating another example of the operation that is executed by the processing unit which is provided in the power supply control device shown in FIG. 3;

FIG. 11 is an exemplary block diagram showing another example of the structure of the power supply control device which is provided in the computer shown in FIG. 1;

FIG. 12 is an exemplary diagram showing an example of the structure of the control program for controlling the operation of the power supply control device shown in FIG. 11; and

FIG. 13 is an exemplary flow chart illustrating an example of the operation that is executed by a processing unit which is provided in the power supply control device shown in FIG. 11.

### DETAILED DESCRIPTION

Various embodiments according to the invention will be described hereinafter with reference to the accompanying drawings. In general, according to one embodiment of the invention, a power supply control device controls a switching power supply circuit by a pulse width modulation signal. The power supply control device includes: a memory which stores a control program including a plurality of instructions for executing a procedure of a power supply control process which controls a duty ratio of the pulse width modulation signal based on an output voltage value of the switching power supply circuit and a target voltage value, a total execution time of the plurality of instructions included in the control program agreeing with a period of the pulse width modulation signal; and a processing unit which executes the power supply control process for each period of the pulse width modulation signal by repeatedly executing the plurality of instructions included in the control program without interruption.

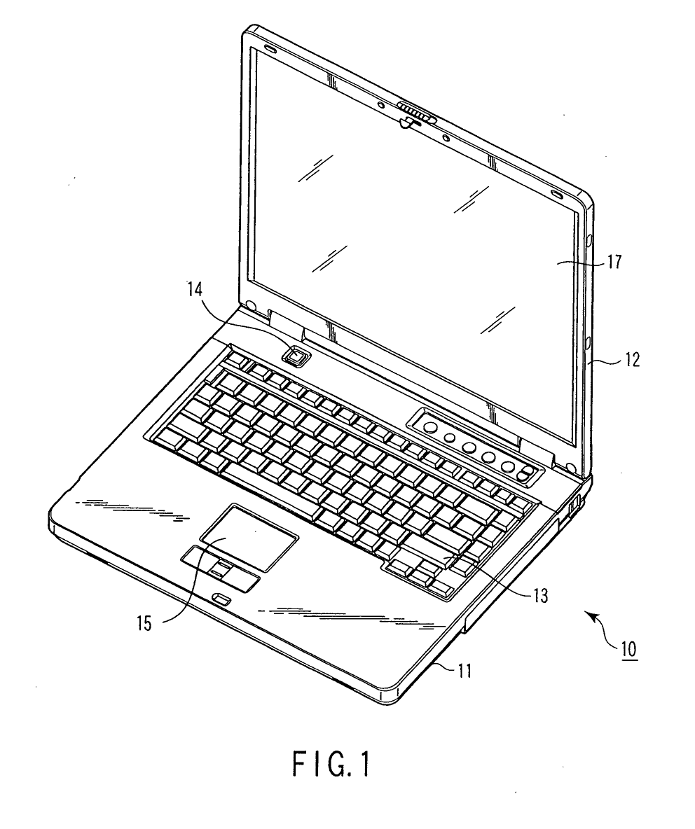

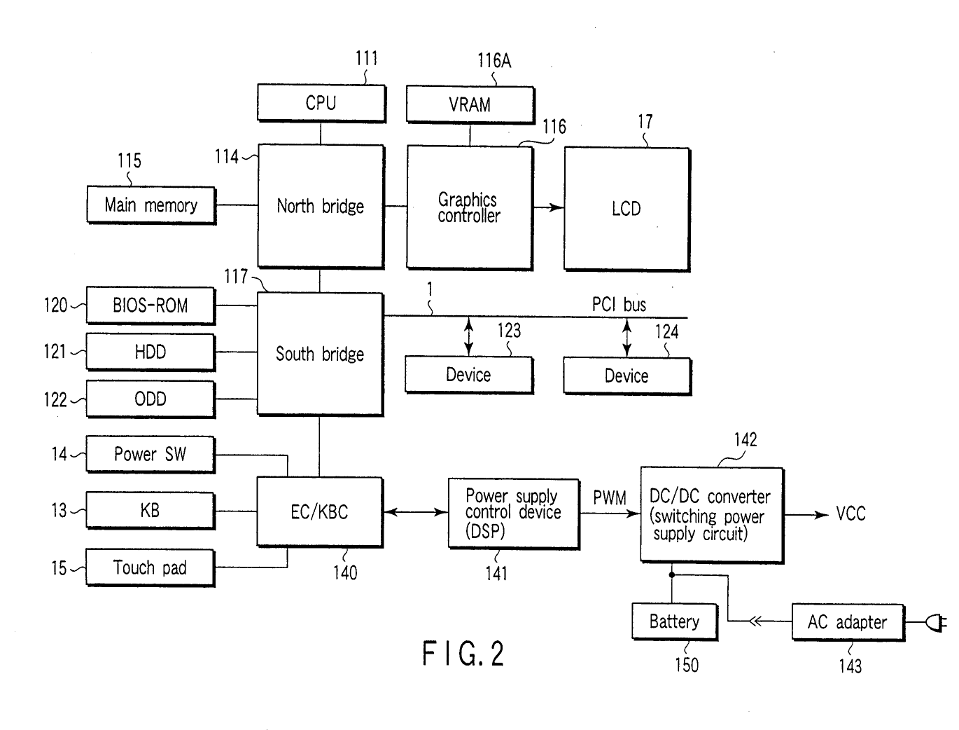

Referring to FIG. 1 and FIG. 2, the structure of an electronic apparatus according to the embodiment of the invention is described. The electronic apparatus is realized, for example, as a battery-powerable notebook-type portable personal computer 10.

FIG. 1 is a perspective view showing the computer 10 in the state in which a display unit thereof is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is attached to the computer main body 11 such that the display unit 12 is freely rotatable between an open position and a closed position. The computer main body 11 has a thin box-shaped casing in which a battery can detachably be attached. The battery is mounted in a battery receiving unit which is provided, for example, in a bottom surface of the computer main body 11.

A keyboard 13, a power button switch 14 for powering on/off the computer 10 and a touch pad 15 are disposed on the top surface of the computer main body 11.

Next, referring to FIG. 2, the system configuration of the computer 10 is described.

The computer 10, as shown in FIG. 2, comprises a CPU 111, a north bridge 114, a main memory 115, a graphics controller 116, a south bridge 117, a BIOS-ROM 120, a hard disk drive (HDD) 121, an optical disc drive (ODD) 122, various PCI devices 123, 124, an embedded controller/keyboard controller IC (EC/KBC) 140, a power supply control device 141, and a DC/DC converter 142.

The CPU 111 is a processor that is provided for controlling the operation of the computer 10. The CPU 111 executes an operating system and various application programs, which are loaded in the main memory 115 from the HDD 121. The CPU 111 also executes a system BIOS (Basic Input/Output System) that is stored in the BIOS-ROM 120. The system BIOS is a program for hardware control.

The north bridge 114 is a bridge device that connects a local bus of the CPU 111 and the south bridge 117. The north bridge 114 includes a memory controller that access-controls the main memory 115. The north bridge 114 has a function of executing communication with the graphics controller 116 via, e.g. a PCI Express bus.

The graphics controller 116 is a display controller for controlling the LCD 17 that is used as a display monitor of the computer 10. The graphics controller 116 has a video memory (VRAM) 116A and generates a video signal, which forms a screen image to be displayed on the LCD 17, on the basis of display data that is written in the video memory (VRAM) 116A by the OS/application program.

The south bridge 117 is connected to a PCI bus 1 and executes communication with the PCI devices 123 and 124 via the PCI bus 1. The south bridge 117 includes an IDE (Integrated Drive Electronics) controller or a Serial ATA controller for controlling the hard disk drive (HDD) 121 and optical disc drive (ODD) 122.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 has a function of powering on/off the computer 10 in response to the user's operation of the power button switch 14. The power on/off control of the computer 10 is executed by cooperation of the EC/KBC 140 and power supply control device 141.

The power supply control device 141 is a device which controls the DC/DC converter 142 by a pulse width modulation signal (PWM signal) and is realized by a DSP (Digital Signal Processor) or a 1-chip microcomputer. In the description below, it is assumed that the power supply control device 141 is realized by the DSP.

The power supply control device 141 executes a power supply control process for controlling the duty ratio of the PWM signal on the basis of an output voltage value of the DC/DC converter 142 and a target voltage value. This power supply control process is executed by a processing unit (processor) which is provided in the power supply control device 141. The power supply control process is executed for each period of the PWM signal.

The DC/DC converter 142 is a switching power supply circuit which is controlled by the PWM signal. The DC/DC converter 142 converts a DC power supply voltage value of DC power from a battery 150 which is mounted in the computer main body 11, or a DC power supply voltage value of DC power from an AC adapter which is connected to the computer main body 11 as an external power supply, to a desired output DC power supply voltage value (hereinafter referred to simply as “output voltage value”). The DC/DC converter 142 includes a switching element which is switch-controlled by the PWM signal. The output voltage value of the DC/DC converter 142 varies in accordance with the duty ratio of the PWM signal.

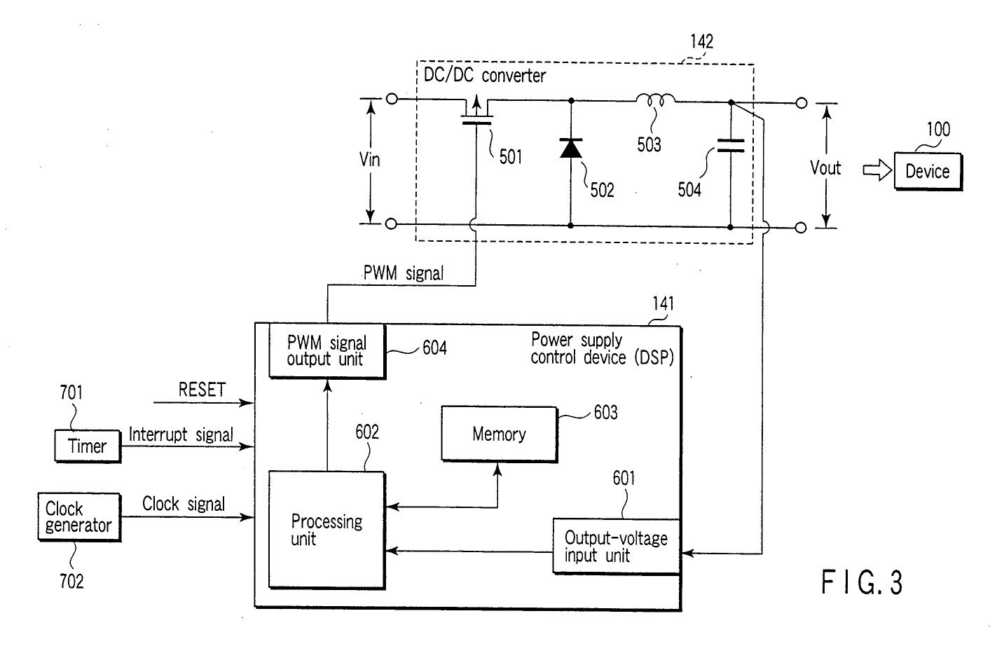

Next, referring to FIG. 3, examples of the structures of the power supply control device 141 and DC/DC converter 142 are described.

The DC/DC converter 142 comprises a transistor (FET) 501 which functions as the above-described switching element, a free wheel diode 502, a coil 503 and a capacitor 504. The DC/DC converter 142 converts an input voltage Vin to an output voltage Vout. The output voltage Vout is supplied to a certain device 100 in the computer 10 as operation power. The device 100 is an arbitrary one of the components shown in FIG. 2.

The power supply control device 141 includes an output-voltage input unit 601, a processing unit 602, a memory 603 and a PWM signal output unit 604. The power supply control device 141 is reset by a reset (RESET) signal which is supplied from the outside of the power supply control device 141. In addition, the power supply control device 141 has an interrupt input terminal for receiving an interrupt signal which is supplied from an interrupt signal generating unit 701, such as a timer, which is provided on the outside of the power supply control device 141. The power supply control device 141 operates in sync with a clock signal which is supplied from a clock generator 702.

The output-voltage input unit 601 is connected to an output terminal of the DC/DC converter 142, and receives the output voltage Vout from the DC/DC converter 142. The output-voltage input unit 601 converts the value of the output voltage Vout from an analog value to a digital value.

The processing unit 602 is a processor which executes a power supply control process for controlling the duty ratio of the PWM signal on the basis of the output voltage value of the DC/DC converter 142 and a target voltage value. The processing unit 602 executes the above-mentioned power supply control process by executing a control program which is stored in the memory 603 and which describes the procedure of the power supply control process.

The power supply control process includes a process of acquiring the output voltage value of the DC/DC converter 142 from the output-voltage input unit 601, a process of calculating a target duty ratio of the PWM signal on the basis of the acquired output voltage value and a predetermined target voltage value, and a process of outputting the calculated target duty ratio to the PWM signal output unit 604 as control data.

The PWM signal output unit 604 generates a PWM signal for switch-controlling the FET 501. The PWM signal output unit 604 is configured to vary the duty ratio of the PWM signal in accordance with the control data from the processing unit 602.

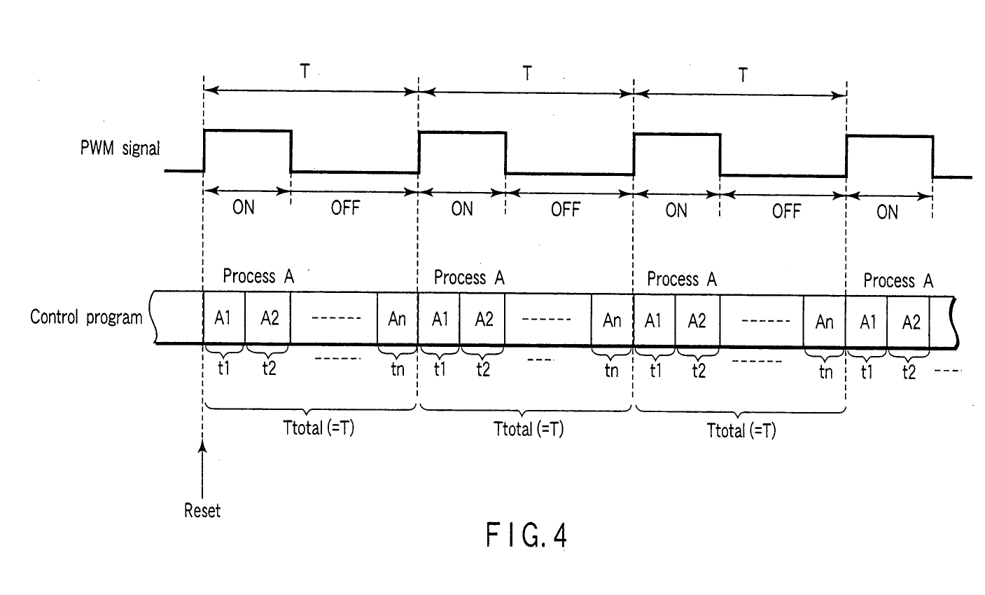

Next, referring to FIG. 4, an example of the structure of the control program is explained.

The control program includes a plurality of instructions A1, A2, . . . , An for executing the procedure of the above-described power control process. Specifically, a statement including the instructions A1, A2, . . . , An describes the procedure of the power supply control process.

In the present embodiment, in order to execute the power supply control process in sync with the PWM signal and for each period of the PWM signal, the total execution time Ttotal of the instructions A1, A2, . . . , An agrees with the period T of the PWM signal. That is, the total execution time Ttotal agrees with the time of an one cycle of the PWM signal. The total execution time Ttotal is a sum of execution times t1, t2, . . . , tn of the instructions A1, A2, . . . , An.

The processing unit 602 repeatedly executes the instructions A1, A2, . . . , An without interruption. Thereby, it becomes possible to execute the power supply control process (process A in FIG. 4) in sync with the PWM signal and for each period T of the PWM signal, without the need to execute a special synchronization process, such as an interrupt process, for each period T. In other words, since an overhead for the interrupt process is needless, the power supply control process can be executed for each period T of the PWM signal without increasing the period T of the PWM signal or using an expensive high-speed DSP.

When the power supply control device 141 is reset, the PWM signal output unit 604 starts outputting the PWM signal whose period T is a specified fixed value, and the processing unit 602 starts executing the control program, that is, the instructions A1, A2, . . . , An. Thereby, the start timing of each period of the PWM signal can also be made to agree with the start timing of the execution of the instruction group including the instructions A1, A2, . . . , An.

In order to execute the power supply control process in sync with the PWM signal and for each period T of the PWM signal, it should suffice to meet the sole condition that the execution time of the instruction group including the instructions A1, A2, . . . , An, i.e. the total execution time Ttotal of the instructions A1, A2, . . . , An, agrees with the period T of the PWM signal. The start timing of each period of the PWM signal does not need to necessarily coincide with the start timing of the execution of the instruction group.

Next, a description is given of a method of finely adjusting the length of the total execution time Ttotal.

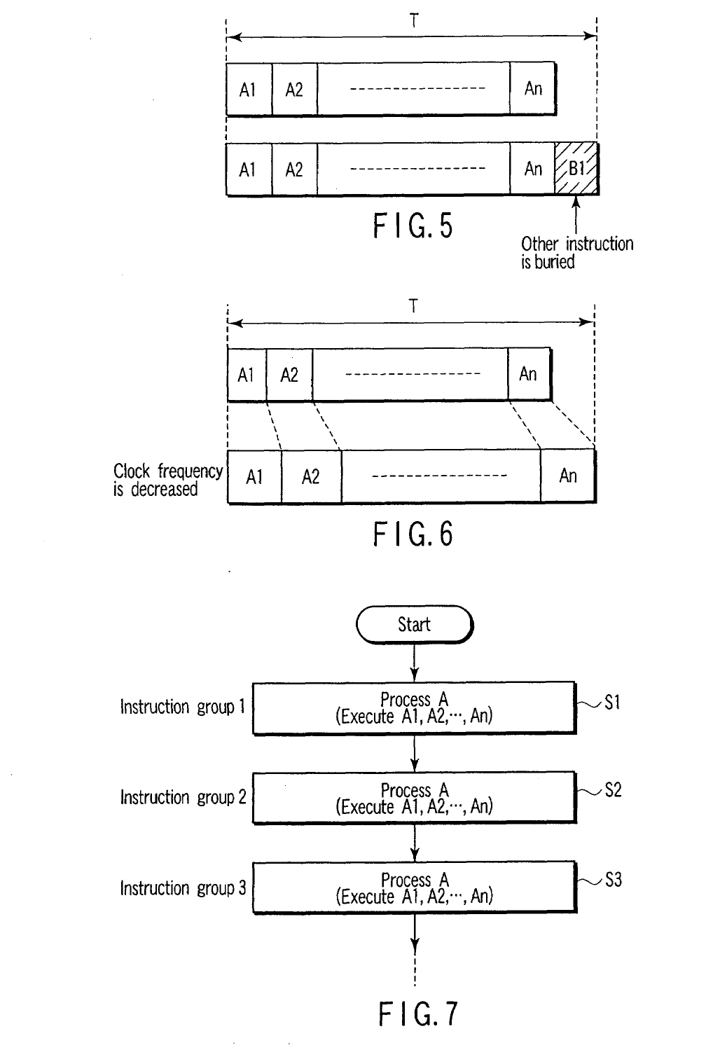

The period T of the PWM signal is predetermined by, for example, the circuit specifications of the DC/DC converter 142. If the execution time of the instruction group including the instructions A1, A2, . . . , An is shorter than the period T, the execution time of the instruction group can be made to agree with the period T by burying another instruction B, such as a null instruction, in the instruction group as one of the instructions for carrying out the procedure of the power supply control process, as shown in FIG. 5. Instead of burying the instruction B, it is possible to decrease, as shown in FIG. 6, the frequency of the clock signal that is supplied to the processing unit 602, thereby increasing the execution time of each of the instructions A1, A2, . . . , An. In this case, the power consumed by the power supply control device 141 can also be reduced.

Next, referring to a flow chart of FIG. 7, the operation of the processing unit 602 is described.

The control program can be composed of a plurality of successive instruction groups (instruction groups 1, 2, 3, . . . ). Each instruction group includes the above-mentioned instructions A1, A2, . . . , An. In this case, the processing unit 602 can repeatedly execute the instructions A1, A2, . . . , An without interruption, simply by successively executing the successive instruction groups included in the control program.

Specifically, the processing unit 602 first executes the power supply control process (process A) by executing the first instruction group 1 (instructions A1, A2, . . . , An) (block S1). Subsequently, the processing unit 602 executes the power supply control process (process A) by executing the second instruction group 2 (instructions A1, A2, . . . , An) (block S2). Then, the processing unit 602 executes the power supply control process (process A) by executing the third instruction group 3 (instructions A1, A2, . . . , An) (block S3).

In this manner, the instruction groups (instruction groups 1, 2, 3, . . . ) are repeatedly executed by the processing unit 602.

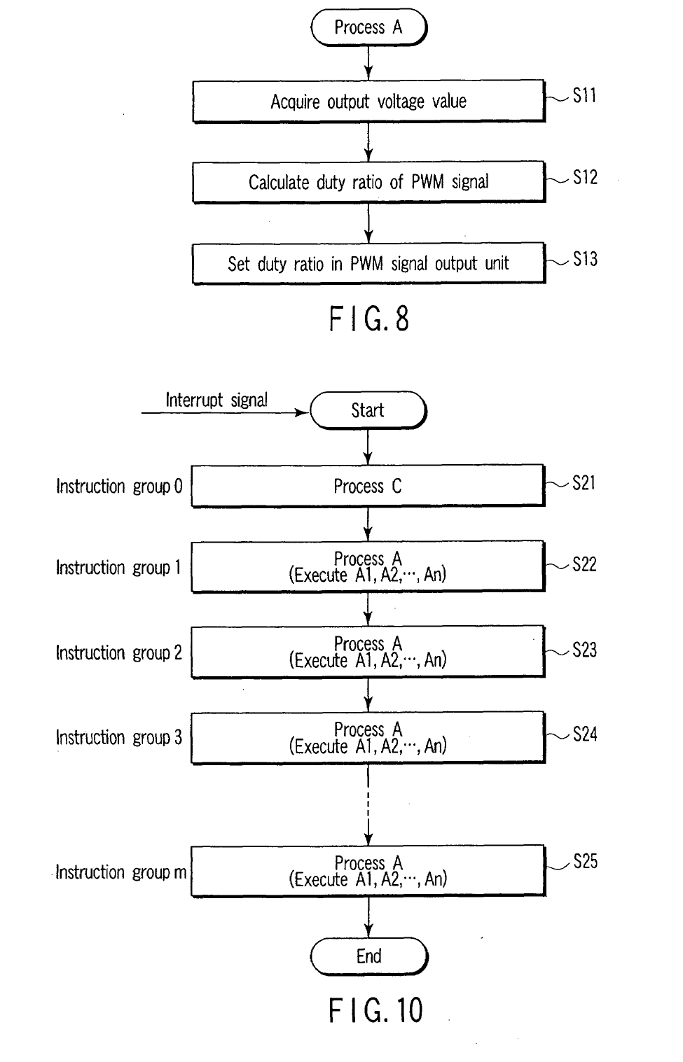

Next, referring to a flow chart of FIG. 8, the procedure of the power supply control process, which is executed for each period T of the PWM signal, is described.

The processing unit 602 first executes a process of acquiring the output voltage value of the DC/DC converter 142 from the output-voltage input unit 601 (block S11). The processing unit 602 then executes a process of calculating a target duty ratio of the PWM signal on the basis of a difference between the predetermined target voltage value and the acquired output voltage value, or the ratio between the target voltage value and the acquired output voltage value (block S12). Thereafter, the processing unit 602 executes a process of setting the control data indicative of the calculated target duty ratio in the PWM signal output unit 604 (block S13).

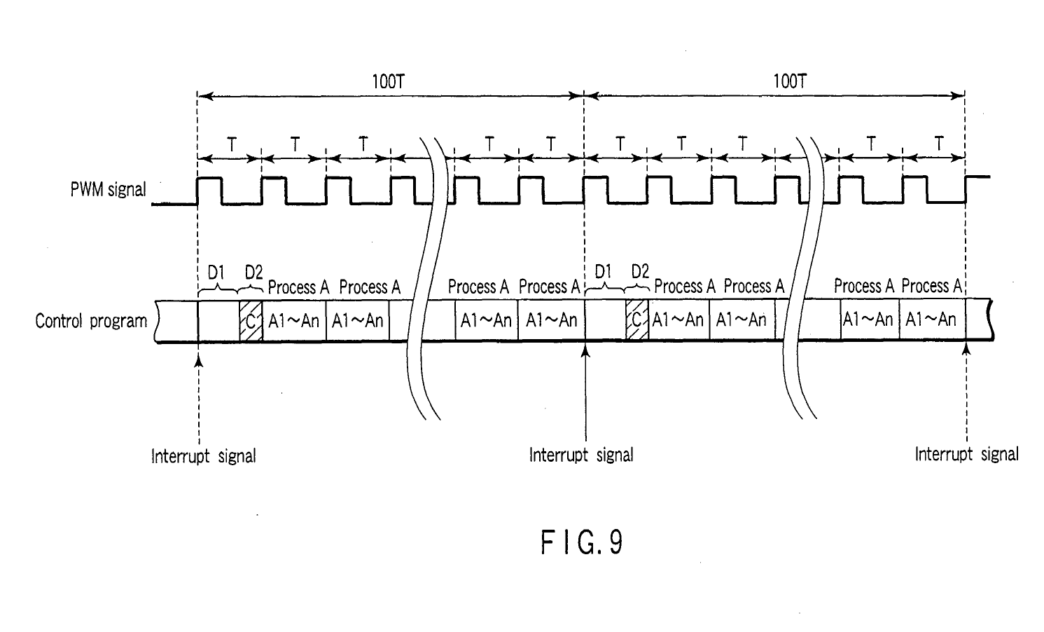

Next, referring to FIG. 9, a description is given of a process for correcting an error in synchronism between the power supply control process and the PWM signal.

With the passing of many periods T, it is possible that an error (sync error) occurs and, for example, the execution timing of the power supply control process slightly delays relative to each period T of the PWM signal.

In FIG. 9, an interrupt signal is used in order to eliminate the sync error. The interrupt signal is supplied from the interrupt signal generating unit 701, such as a timer, to the processing unit 602 at a ratio of once in a plurality of periods T of the PWM signal, for instance, at a ratio of once in 100T. The interrupt signal is generated, for example, at a start timing of each period T.

The control program is composed of a plurality of successive instruction groups each including instructions A1, A2, . . . , An. The execution time of each instruction group agrees with the period T of the PWM signal, as described above. Each time the processing unit 602 receives the interrupt signal, the processing unit 602 starts execution of the successive instruction groups. Thereby, the execution timing of the power supply control process can be corrected, for example, at a ratio of once in 100T.

A predetermined delay time D1 is consumed until the processing unit 602 is able to start the power supply control process after receiving the interrupt signal, as described above. Thus, the power supply control process cannot be executed in the first period T after the reception of the interrupt signal. However, since the interrupt signal is generated at the ratio of, e.g. once in 100T, the output voltage value of the DC/DC converter 142 can be controlled with sufficiently high precision.

An instruction group for executing a process C for time adjustment is buried, for example, at the beginning part of the control program. The content of the instruction group for executing the process C is determined, for example, such that the total time (D1+D2) of a execution time D2 of the process C and the delay time D1 agrees with the period T. Thereby, in the second and following periods T after the generation of the interrupt signal, the power supply control process can be executed in sync with the PWM signal and for each period T of the PWM signal. That is, the power supply control process is executed in every cycle of the PWM signal.

Next, referring to a flow chart of FIG. 10, a description is given of the operation which is executed by the processing unit 602 in the interrupt process.

The control program is composed of an instruction group 0 for executing the above-described process C for time adjustment and a plurality of successive instruction groups (instruction groups 1, 2, 3, . . . , m). The value of m is, e.g. 100. Each of the instruction groups 1, 2, 3, . . . , m includes the above-described instructions A1, A2, . . . , An. Each time the processing unit 602 receives the interrupt signal, the processing unit 602 executes the control program in the interrupt process.

Specifically, in the interrupt process, the processing unit 602 first executes the process C for time adjustment by executing the first instruction group 0 (block S21). Then, the processing unit 602 successively executes the instruction group 1 (instructions A1, A2, . . . , An), the instruction group 2 (instructions A1, A2, . . . , An), the instruction group 3 (instructions A1, A2, . . . , An), . . . , the instruction group m (instructions A1, A2, . . . , An) (blocks S22 to S25).

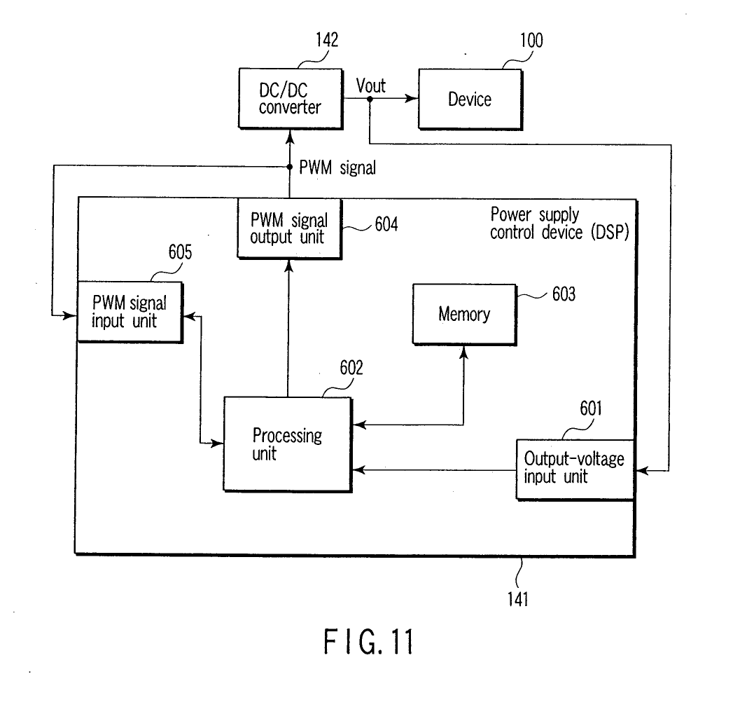

Next, another example of the structure of the power supply control device 141 is described with reference to FIG. 11.

A power supply control device 141 shown in FIG. 11 includes a PWM signal input unit 605 in addition to the above-described output-voltage input unit 601, processing unit 602, memory 603 and PWM signal output unit 604. The PWM signal, which is output from the PWM signal output unit 604, is input to the PWM signal input unit 605.

The processing unit 602 can access the PWM signal input unit 605 and can determine whether the PWM signal is varied (polling process).

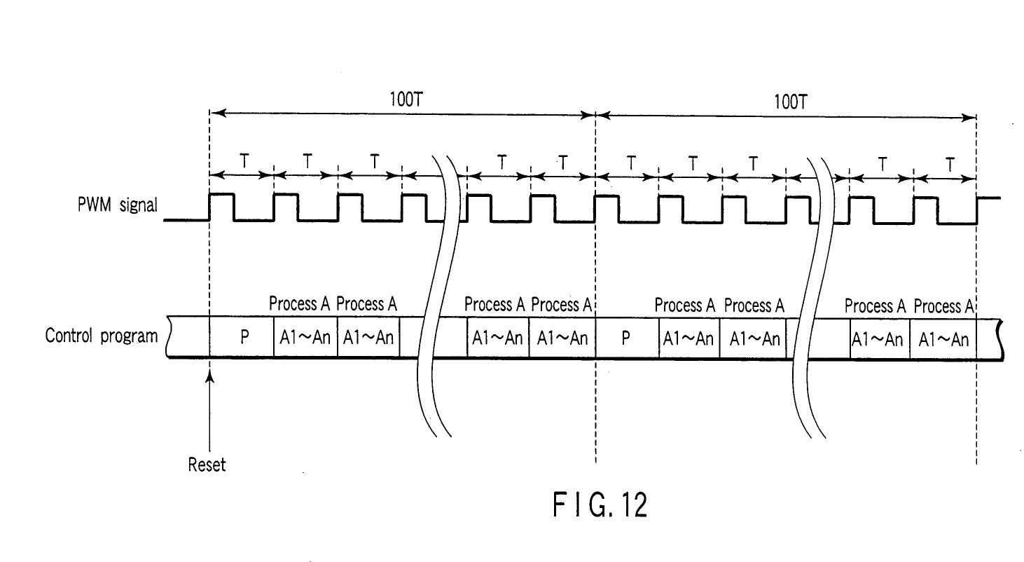

FIG. 12 shows an example of the structure of the control program in which instructions for executing the polling process are added.

The control program includes an instruction group for executing the procedure of the polling process (P) for monitoring a variation in the PWM signal, and a plurality of successive instruction groups each including instructions A1, A2, . . . , An.

The processing unit 602 executes the instruction group for executing the procedure of the polling process (P), thereby accessing the PWM signal input unit 605 and determining whether the PWM signal is varied or not (e.g. whether the PWM signal rises or not). If it is determined that the PWM signal is varied, the processing unit 602 starts execution of the successive instruction groups 1, 2, 3 . . . . The polling process (P) is executed at a ratio of once in a plurality of periods T of the PWM signal, for instance, at a ratio of once in 100T. Thereby, the above-mentioned sync error can be corrected.

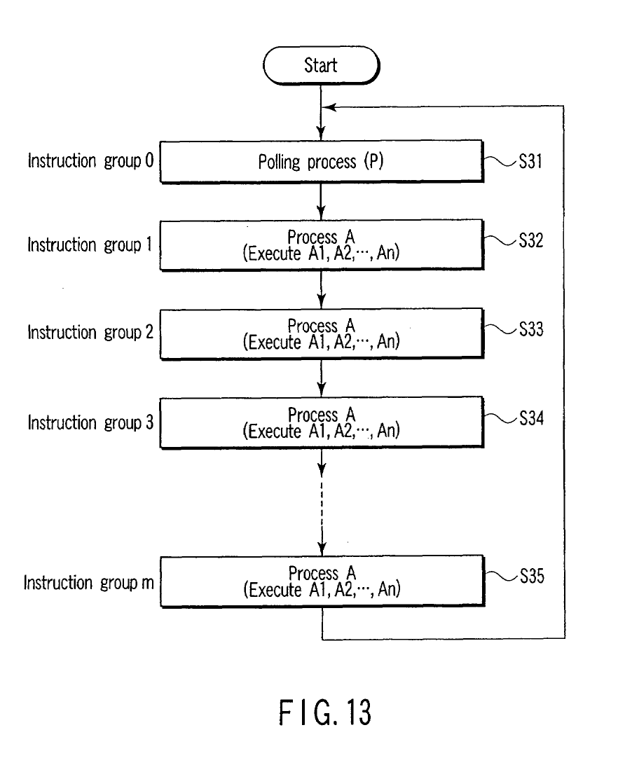

Next, the operation of the processing unit 602 is described with reference to a flow chart of FIG. 13.

The control program includes an instruction group 0 for executing the polling process (P) for monitoring a variation in the PWM signal, and a plurality of successive instruction groups (instruction groups 1, 2, 3, . . . , m). The value of m is, e.g. 100. Each of the instruction groups 1, 2, 3, . . . , includes the above-described instructions A1, A2, . . . , An.

The processing unit 602 repeatedly executes the instruction group 0, and instruction groups 1, 2, 3, . . . , m.

Specifically, the processing unit 602 first executes the polling process P by executing the first instruction group 0 (block S31). In block S31, the processing unit 602 periodically accesses the PWM signal input unit 605 and determines whether the PWM signal is varied. If it is determined that the PWM signal is varied, the processing unit 602 successively executes the instruction group 1 (instructions A1, A2, . . . , An), instruction group 2 (instructions A1, A2, . . . , An), instruction group 3 (instructions A1, A2, . . . , An), . . . , instruction group m (instructions A1, A2, . . . , An) (blocks S32 to S35).

If the execution of the instruction group m is completed, the processing unit 602 executes the first instruction group 0 once again (block S31). In short, the process of blocks S31 to S35 is repeatedly executed by the processing unit 602.

In the meantime, the instruction group 0 may be positioned after the instruction group m.

As has been described above, according to the present embodiment, the power supply control process is executed by using the instructions A1, A2, . . . , An, the total execution time of which agrees with the period T of the PWM signal. Thereby, the power supply control process can be executed in sync with the PWM signal and in every period T of the PWM signal, without an overhead for an interrupt process, etc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power supply control device which controls a switching power supply circuit by a pulse width modulation signal, comprising:
a memory which stores a control program including a plurality of instructions for executing a procedure of a power supply control process which controls a duty ratio of the pulse width modulation signal based on an output voltage value of the switching power supply circuit and a target voltage value, a total execution time of the plurality of instructions included in the control program agreeing with a period of the pulse width modulation signal; and
a processing unit which executes the power supply control process for each period of the pulse width modulation signal by repeatedly executing the plurality of instructions included in the control program without interruption.

2. The power supply control device according to claim 1, wherein the control program includes a plurality of successive instruction groups each including the plurality of instructions, and
the processing unit is configured to successively execute the plurality of instruction groups, to repeatedly execute the plurality of instructions without interruption.

3. The power supply control device according to claim 1, further comprising a pulse width modulation signal output unit which is configured to vary the duty ratio of the pulse width modulation signal in accordance with control data, and
the power supply control process includes a process of acquiring the output voltage value of the switching power supply circuit, a process of calculating a target duty ratio of the pulse width modulation signal based on the acquired output voltage value and the target voltage value, and a process of outputting the calculated target duty ratio to the pulse width modulation signal output unit as the control data.

4. The power supply control device according to claim 1, wherein the control program includes a plurality of successive instruction groups each including the plurality of instructions, and
the processing unit starts execution of the plurality of instruction groups each time the processing unit receives an interrupt signal, the interrupt signal being supplied from outside at a ratio of once in a plurality of periods of the pulse width modulation signal.

5. The power supply control device according to claim 1, wherein the control program includes instructions for executing a procedure of a polling process for monitoring a variation in the pulse width modulation signal, and a plurality of successive instruction groups each including the plurality of instructions, and
the processing unit determines whether the pulse width modulation signal is varied, by executing the instructions for executing the procedure of the polling process, and starts execution of the plurality of instruction groups when it is determined that the pulse width modulation signal is varied.

6. An electronic apparatus comprising:
a device;
a switching power supply circuit which is controlled by a pulse width modulation signal and outputs operation power to the device;
a memory which stores a control program including a plurality of instructions for executing a procedure of a power supply control process which controls a duty ratio of the pulse width modulation signal based on an output voltage value of the switching power supply circuit and a target voltage value, a total execution time of the plurality of instructions included in the control program agreeing with a period of the pulse width modulation signal; and
a processing unit which executes the power supply control process for each period of the pulse width modulation signal by repeatedly executing the plurality of instructions included in the control program without interruption.

7. The electronic apparatus according to claim 6, wherein the control program includes a plurality of successive instruction groups each including the plurality of instructions, and
the processing unit is configured to successively execute the plurality of instruction groups, to repeatedly execute the plurality of instructions without interruption.

8. The electronic apparatus according to claim 6, further comprising an interrupt signal generating unit which generates an interrupt signal at a ratio of once in a plurality of periods of the pulse width modulation signal,
wherein the control program includes a plurality of successive instruction groups each including the plurality of instructions, and
the processing unit starts execution of the plurality of instruction groups each time the processing unit receives the interrupt signal from the interrupt signal generating unit.

9. The electronic apparatus according to claim 6, wherein the control program includes instructions for executing a procedure of a polling process for monitoring a variation in the pulse width modulation signal, and a plurality of successive instruction groups each including the plurality of instructions, and
the processing unit determines whether the pulse width modulation signal is varied, by executing the instructions for executing the procedure of the polling process, and starts execution of the plurality of instruction groups when it is determined that the pulse width modulation signal is varied.

10. A power supply control method for controlling a switching power supply circuit by a pulse width modulation signal, comprising:
executing by a processing unit a plurality of instructions for executing a procedure of a power supply control process which controls a duty ratio of the pulse width modulation signal based on an output voltage value of the switching power supply circuit and a target voltage value, the plurality of instructions being included in a control program, a total execution time of the plurality of instructions agreeing with a period of the pulse width modulation signal; and
repeating the execution of the plurality of instructions by the processing unit without interruption, thereby to execute the power supply control process for each period of the pulse width modulation signal.

11. The power supply control method according to claim 10, wherein the control program includes a plurality of successive instruction groups each including the plurality of instructions, and
said repeating the execution of the plurality of instructions includes successively executing by the processing unit the plurality of instruction groups, to repeatedly execute the plurality of instructions without interruption.

12. The power supply control method according to claim 10, wherein the control program includes a plurality of successive instruction groups each including the plurality of instructions, and
said repeating the execution of the plurality of instructions includes causing the processing unit to start execution of the plurality of instruction groups each time an interrupt signal, which is generated at a ratio of once in a plurality of periods of the pulse width modulation signal, is received.

13. The power supply control method according to claim 10, wherein the control program includes instructions for executing a procedure of a polling process for monitoring a variation in the pulse width modulation signal, and a plurality of successive instruction groups each including the plurality of instructions, and
said repeating the execution of the plurality of instructions includes determining whether the pulse width modulation signal is varied, by executing by the processing unit the instructions for executing the procedure of the polling process, and causing the processing unit to start execution of the plurality of instruction groups when it is determined that the pulse width modulation signal is varied.
